(19) United States
(12) Patent Application Publication
(10) Pub. No.: US 2003/0104840 A1
(43) Pub. Date: Jun. 5, 2003

(54) Method and apparatus for minimally intrusive advertising

(75) Inventors: Robert Gerard O'Hare, Hinsdate, IL (US); Peter John Lyons, Chicago, IL (US); Jeffrey Keith Berger, Palatine, IL (US)

Correspondence Address: POSZ & BETHARDS, PLC, 11250 ROGER BACON DRIVE, SUITE 10, RESTON, VA, 20190, US

(73) Assignee: MOTOROLA, INC.

(21) Appl. No.: 10/001,984

(22) Filed: Dec. 5, 2001

(51) Int. Cl. H04M 1/00

(52) U.S. Cl. 455/566; 455/419; 455/412

(57) ABSTRACT

A communications device and analogous methods therein arranged and constructed to display an advertisement so as to limit intrusiveness for a user of the device includes a transceiver for receiving and sending communications signals; a user input output (I/O) including a display; and a controller, all inter-coupled, for controlling the transceiver and interfacing with the user I/O, the controller, further including a memory for storing an advertisement message, operating to: interface with the display to display a symbol corresponding to the advertisement message in a manner that does not interfere with the users utilization of the communications device; initiate a display of the advertisement message on the display when normal utilization of the electronic device will not be compromised.

### FIELD OF THE INVENTION

This invention relates in general to systems for advertising, and more specifically to a method and apparatus for minimally intrusive advertising in such systems.

### BACKGROUND OF THE INVENTION

Systems for advertising are known. Users of electronic devices, computers, etc, for browsing the Internet are familiar with pushed advertising. Advertising messages that are not requested but are sent to you while you are browsing are often referred to as push, rather than pull advertising. These messages can be intrusive in that they essentially take over the display and have to be dealt with before a user can continue with their intended task. The advertisements that are brief and for the most part non-intrusive, iconic, require the user to access a remote file for useful information. Users of wireless electronic devices such as messaging devices and browser equipped cellular or PCS phones are also familiar with intrusive advertisements.

What is needed is a method and apparatus for displaying advertising on an electronic device that is minimally intrusive to a user of the device. Preferably the user will be able to act upon the advertisement.

### BRIEF DESCRIPTION OF THE DRAWINGS

The accompanying figures, where like reference numerals refer to identical or functionally similar elements throughout the separate views and which are incorporated in and form part of the specification, serve to further illustrate various embodiments in accordance with the present invention. The figures together with the detailed description, hereinafter below, serve to explain various principles and advantages in accordance with the present invention.

FIG. 1 depicts, in a simplified and representative form, a diagram or route that an electronic device may travel;

FIG. 2 depicts a block diagram of a preferred embodiment of a communications device in accordance with the present invention;

FIGS. 3A-D depicts various exemplary displays for the device of FIG. 3 according to the present invention;

FIG. 4 shows a preferred method of displaying an advertisement according to the present invention; and

FIG. 5 shows a further preferred method of doing business including advertising according to the present invention.

### DETAILED DESCRIPTION OF PREFERRED EMBODIMENT

In overview form the present disclosure concerns systems for advertising that provide minimally intrusive advertising to electronic devices or communications units or more specifically users thereof operating therein. More particularly various inventive concepts and principles embodied in methods and apparatus for the access of advertising messages and display thereof in a non-intrusive manner including capability to act upon the advertising are discussed. The advertising systems of particular interest are those that operate with electronic devices and preferably wireless electronic devices with wireless browsers that are being deployed in communications systems such as PCS systems, GPRS systems, or will be deployed in those systems being planned that employ IPv6 such as 3^{rd} generation IP based systems or other systems using IP addressing and allowing for mobility of the communications services users.

As further discussed below various inventive principles and combinations thereof are advantageously employed to essentially decouple the notice or indication of an advertisement message and the message, thus alleviating various problems associated with known systems while still facilitating timely and relevant access to and utilization of the messages at the users convenience provided these principles or equivalents thereof are utilized.

The instant disclosure is provided to further explain in an enabling fashion the best modes of making and using various embodiments in accordance with the present invention. The disclosure is further offered to enhance an understanding and appreciation for the inventive principles and advantages thereof, rather than to limit in any manner the invention. The invention is defined solely by the appended claims including any amendments made during the pendency of this application and all equivalents of those claims as issued.

It is further understood that the use of relational terms, if any, such as first and second, top and bottom, and the like are used solely to distinguish one from another entity or action without necessarily requiring or implying any actual such relationship or order between such entities or actions. Much of the inventive functionality and many of the inventive principles are best implemented with or in software programs or instructions. It is expected that one of ordinary skill, notwithstanding possibly significant effort and many design choices motivated by, for example, available time, current technology, and economic considerations, when guided by the concepts and principles disclosed herein will be readily capable of generating such software instructions and programs with minimal experimentation. Therefore further discussion of such software, if any, will be limited in the interest of brevity and minimization of any risk of obscuring the principles and concepts in accordance with the present invention.

Referring initially to FIG. 1 a simplified and representative diagram or route that an electronic device may travel will be discussed. It is expected that this discussion will help provide some common languages as well as familiarize the reader with some of the problems of present systems and some of the opportunities envisioned by the principles and concepts according to the present invention. FIG. 1 depicts a path or route 101 that an electronic device 103, preferably a wireless electronic device, traverses over some period of time. Device 103 is a cellular phone, PCS phone, messaging device, personal digital assistant, broadcast or entertainment receiver (Bluetooth equipped if need be), or other device with at least the ability to receive messages and preferably ability to transmit messages in order to take full advantage of the principles and concepts herein discussed. While FIG. 1 depicts or suggests a mobile device, a portable device traveling on the body of a person would serve our purposes equally well. In any event while traversing the route, the device 103 will be proximate or geographically adjacent or near to, first, a supplier 105 of goods or services or business and then, second, a supplier 107 or business.

Proximity to supplier 105 would have to be sensed by the supplier or device. Where the device is equipped with a low power wireless transceiver, such as Bluetooth for connecting to a local area network the supplier 105 can sense whether a connection is attempted and thus know the device is proximate or near to the suppliers business establishment and send appropriate messages. In the example where the device passes near to supplier 107, a coverage area 109 for a transmitter is shown. This could be the coverage area, for example, of a cellular base site or some broadcast site, or the like. Supplier 107 can simply broadcast or make arrangements with a local carrier to broadcast his messages and know that when a device such as device 103 is proximate they will pick up the signals that are broadcast. In this instance supplier 107 does not “know” the device is proximate, but that proximity can still serve our purposes. In the above discussion while there is a multiplicity of possible communications systems discussed it is understood that whichever is used will have to compatible with the electronic device and so on. For the most part, the balance of this disclosure will consider an example of a cellular phone that has a wireless browser. It is believed that from our discussion it will be clear to one of ordinary skill that the principles and concepts discussed and disclosed apply equally to many other electronic devices such as those mentioned above.

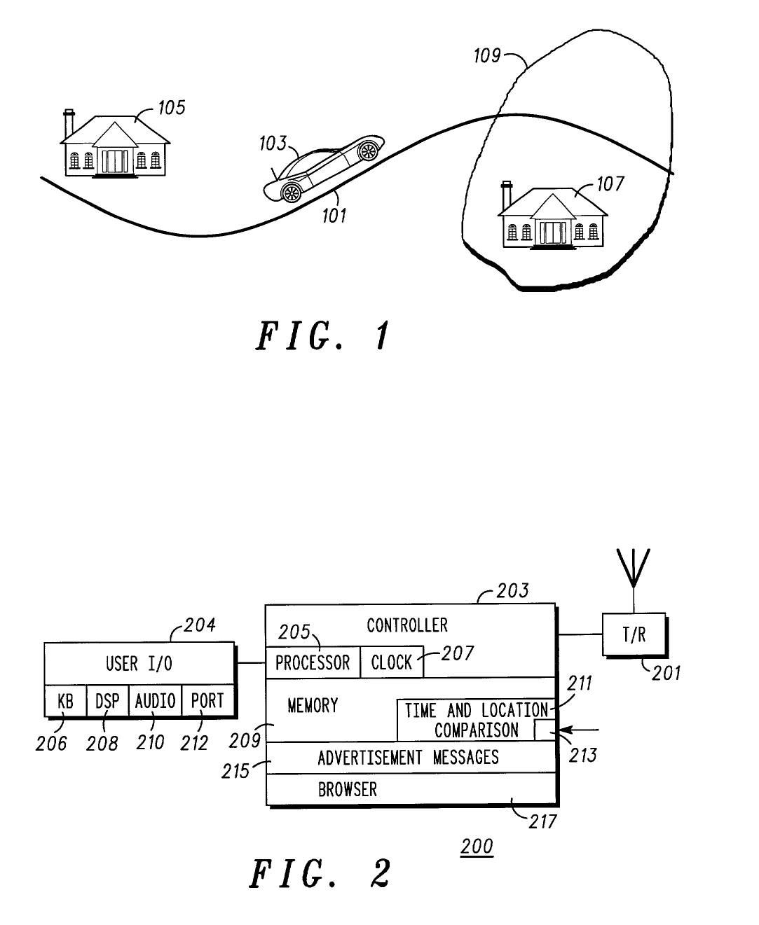

Referring to FIG. 2 a block diagram of a preferred embodiment of a communications device 200 (similar or analogous to device 103) in accordance with the present invention will be reviewed. The communications device is preferably a cellular phone with a wireless browser that is arranged and constructed to display an advertisement so as to limit intrusiveness for a user of the communications device. The communications device includes a transceiver 201 for receiving and sending communications signals in accordance with the relevant protocols and air interfaces as is known. The communications device also includes a user input output (I/O) 204 including a conventional keyboard 206, a display 208 using known technologies such as liquid crystal, an audio function 210 such as microphone and speaker and optionally a port 212 for interfacing to other devices such as computers, GPS receivers, Bluetooth transceivers, etc.

Also included is a controller 203 that is coupled to the transceiver 201 and the user I/O 204. The controller 203 generally is for controlling the transceiver to carry on communications in addition to interfacing with the user I/O to provide for interaction with a user of the device. The controller 203 includes a processor 205 and, as depicted, a clock 207 and further a memory 209. The processor, preferably a microprocessor, and memory, such as a combination of RAM, PROM, or magnetic memory, are conventional known functions available from a wide range of manufacturers. Generally the memory stores software instructions that when executed by the processor cause or allow the controller to perform or undertake its various responsibilities again as known except for the inventive principles and concepts further reviewed below.

The memory 209 also includes software for comparing 211 a prescribed time to the time from the clock or prescribed location values to location information regarding the proximity of a supplier to in some instances determine whether various display activities will be undertaken. Also shown is a port 213, typically part of the controller and coupled to the memory by the processor, for receiving externally supplied location data, such as GPS coordinates, if need be. The memory also includes a location for storing various advertisement messages 215 and preferably a Browser program 217.

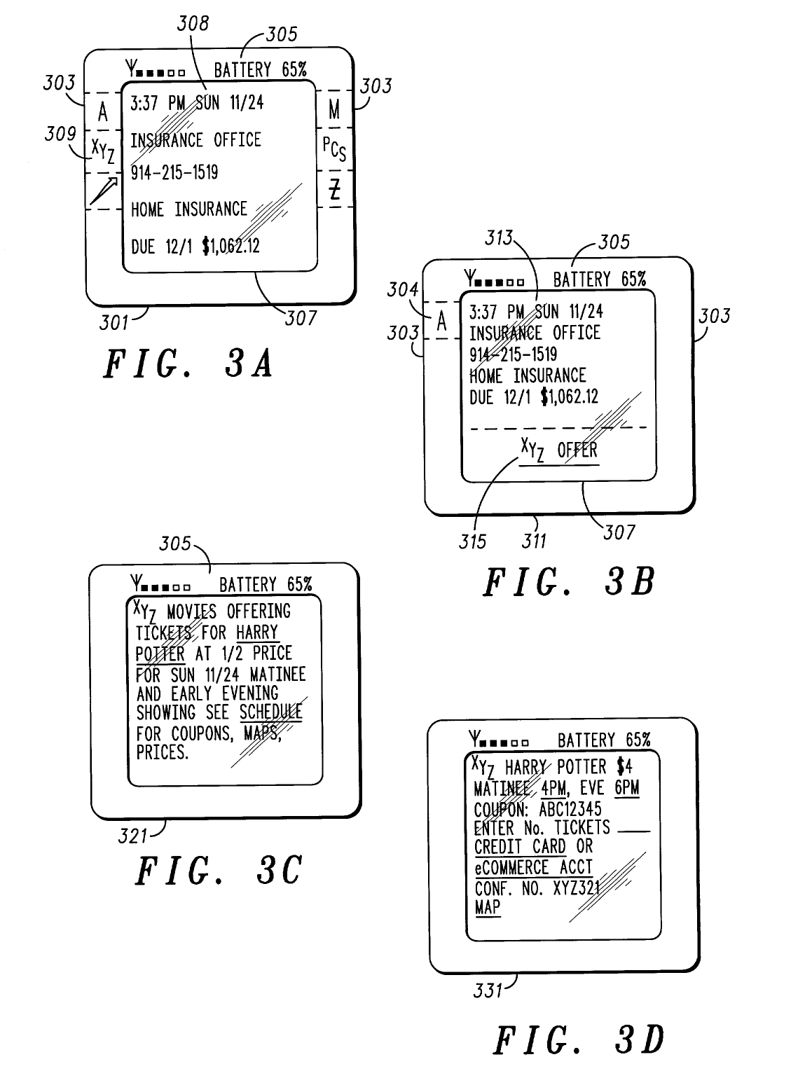

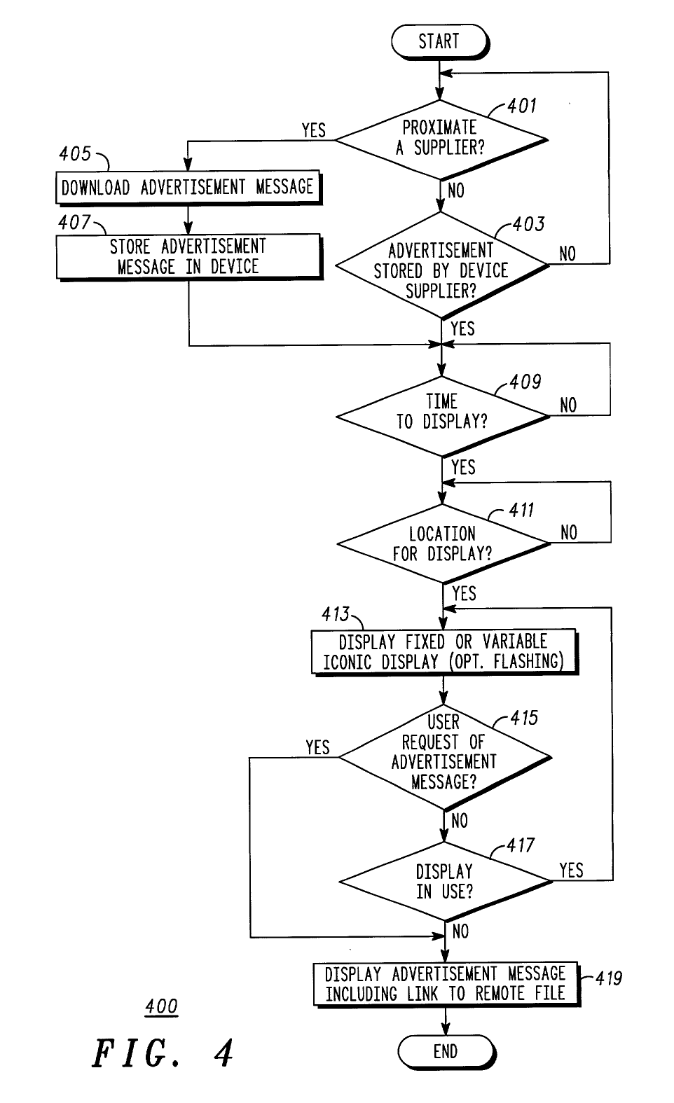

The controller, processor, memory etc. operates to interface with the display 208 to display a symbol corresponding to one of the advertisement messages and, preferably, to a supplier of goods or services, and does so in a minimally intrusive manner or in a manner that does not interfere with the users utilization of the communications device. Examples are discussed with reference to FIG. 3 below. Thereafter the controller operates to initiate a display of the advertisement message when utilization of the communications device will not be compromised and then display the advertisement message on the display.

The controller can be triggered to interface with the display to display the symbol by, for example, proximity to the supplier of goods or services or at a time that corresponds to an indicated time, preferably in an advertisement message. As noted above this proximity may be determined in the simplest case by being within range of a signal that includes the advertisement message or when, greater resolution is needed, by comparing coordinates for the communications device as provided by a known GPS receiver to coordinates supplied with the advertising signal.

The symbol that is displayed or the advertisement message can be supplied by or caused to be stored in the memory by the supplier of the communications device or communications services or the supplier of the goods and services. In short the symbol or advertisement message can be preloaded and triggered as noted or it can be received over the air. In the latter case the controller and the transceiver will operate to download the advertisement message from the supplier based on sufficient proximity to receive a signal from the supplier of the goods or services. It is expected that economic factors or manufacturing concerns will determine when and who supplies the symbols and messages.

The user interacting with the user I/O to recall the message or the controller sensing that the display is not otherwise being utilized will trigger the controller to initiate the display of the advertisement message. This advertisement message, preferably, includes a link to a remote file with further information corresponding to the advertisement message.

Referring to FIGS. 3A-D various exemplary displays of symbols and messages for the device 200 and display 208 of FIG. 2 according to the present invention will be discussed. FIG. 3A depicts in exemplary fashion a display 301 with a fixed display area 303 that is essentially the peripheral area of the display and a variable display area 307 that is preferably bit mapped or pixel based and can display a wide range of video or graphical information under control of the controller. The fixed area is shown with various symbolic information such as the signal strength and battery level meters 305. In addition six symbols or icons or iconic symbols such as xyz 309 are depicted. Due to the display technology these peripheral symbols will need to be included when the communications device is manufactured. It is expected that these symbols or icons are, preferably corporate emblems or trademarks. When the symbol xyz is highlighted or clicked or the controller determines that the display is not otherwise being used an advertisement message, such as shown in 321 would appear.

When these symbols are available and under the proper circumstances (proximity or time for example) the appropriate iconic symbol indicative of the supplier of goods or services can be displayed or activated so as to show up for the user. Note the symbol can be flashing or alternating between enabled and disabled. Also note that the user is not intruded upon as the variable portion of the display 307 shows a message from here the insurance office that has not been affected. While our focus in the present discussion has and will continue to be the visual display please note that the audio function 210 of the user I/O may also be used as a form of alert when an advertisement message is pending.

The second example display 311, FIG. 3B, shows a variable iconic symbol 315, namely xyz offer and a slightly modified or condensed message from the insurance office within the variable area 307. Note: that this display approach is minimally intrusive to the user and that the symbols within the variable area need not be determined prior to manufacture of the device. Again these symbols in the variable or bit mapped area are, preferably, corporate logos, emblems, or trademarks. Of course the display can still have symbols in the fixed area such as 304. As noted above highlighting or clicking the xyz offer symbol is one way to bring up the locally stored advertisement message such as shown at 321. Also all of the display options such as flashing the symbol are available with the variable iconic symbols.

The advertisement message in 321, FIG. 3C, shows HARRY POTTER and SCHEDULE indicating they are links to remote files. One would expect a relatively rich display perhaps highlighting some scenes from the movie if the HARRY POTTER link is highlighted or clicked. At 331, FIG. 3D, is an example of what might be expected if the SCHEDULE link is highlighted. Note this display may be developed with several remote file accesses. For example one selects either 4 PM or 6 PM, receives a coupon number and is asked how many tickets, and is given a choice between credit card and eCommerce account (presumably stored on or within the communications device. The next display includes a confirmation number and a link for a MAP if desired. Thus the goods or services have been purchased based on an electronic transaction.

Referring to FIG. 4 a preferred method of displaying an advertisement according to the present invention will be discussed. FIG. 4 depicts a method 400 of displaying an advertisement on an electronic device that is minimally intrusive for a user of the electronic device. The method starts and at 401 tests whether the device is proximate a supplier of goods and services and if not 403 determines whether an advertisement message was stored by the device supplier and if not the method returns to the start. If step 401 determines that we are near or proximate a supplier (see above for methods of doing so) then step 405 operates to download an advertisement message from the supplier. This message is stored in the device at 407.

If a message was pre-stored or loaded in the device as tested at 403 or after the storing step 407, the method tests whether it is time to display the message or a symbol corresponding to the message at 409. For example the message may be stored with a time to display of 5 PM. Thus at 5 PM the display would be activated as below noted. If it is not the appropriate time and a time is included the process waits until time is up. If there is no time constraint or if that is satisfied the process moves on to step 411 where any location constraint is tested. Here if the device is sufficiently proximate a supplier of goods or services or if there are no location constraints then the advertisement message should be offered or displayed as noted below. If there is a constraint that is not satisfied the process continues to evaluate location for this message.

At step 413 displaying a symbol, preferably a fixed or variable iconic symbol indicative of the supplier of goods or services, that corresponds to the advertisement message on a display of the electronic device in a manner that does not interfere with the users utilization of the electronic device is undertaken. Examples of the type of displays were discussed with reference to FIG. 3 and include flashing the appropriate symbol. Note that displaying this symbol according to the principles discussed above can be triggered by one of proximity to the supplier or time, specifically satisfaction of a time constraint. Storing the advertisement message as noted is facilitated by the supplier of the electronic device (party in supply chain that causes a message to be stored or preloaded) or a supplier of goods and services.

At any rate after 413, step 415 tests whether the user has triggered or requested the advertisement message, by, for example, the appropriate key stroke thereby interacting with the electronic device and thus initiating a display of the message when utilization of the electronic device will not be compromised. If the user has not requested the message at 415 the controller tested to see whether the display appears to be in use at 417 and if not initiates the display of the message. In practice this amounts to sensing that the display is in a normal parked or quiescent state or not otherwise being utilized by noting a lack of activity for a predetermined time such as 10-15 seconds. If the display continues to be in use the process repeats from step 413 thus continuing to display the appropriate icon. If the user requests or the controller determines that displaying the advertisement message will not interfere with or compromise the normal utilization of the device, step 419 displays the advertisement message including link to a remote file for additional information corresponding to said advertisement message if desired. In a preferred form this method would be performed by a cellular phone, a messaging device, a personal digital assistant, or an entertainment device with two way capability and a browser.

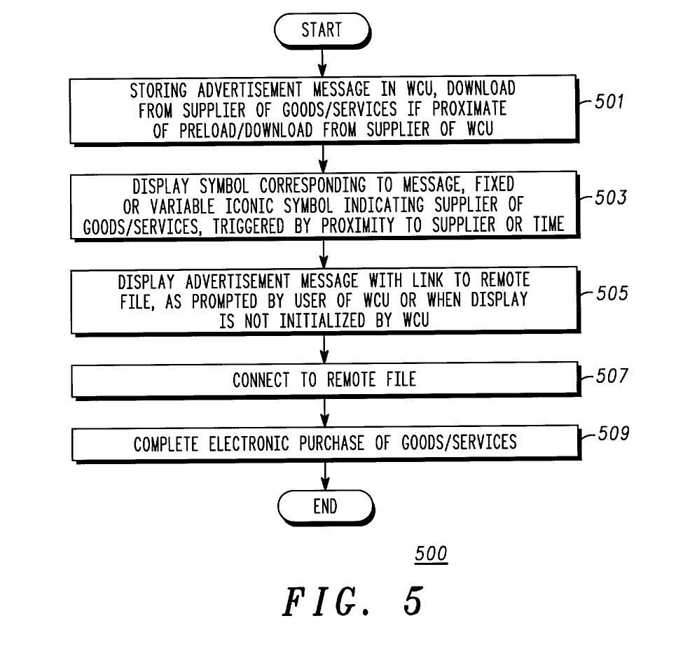

Referring to FIG. 5 a further preferred method of doing business including non-intrusive advertising according to the present invention is discussed. Much of this embodiment makes use of the above discussed principles and concepts so the Fig. And our explanation will be at more of an overview level. The method shown in FIG. 5 is one of doing business with a wireless communications unit (WCU) that includes advertising with limited intrusiveness to a user of the WCU. The WCU is preferably a cellular phone, a messaging device, a personal digital assistant, an entertainment device, or similar communications unit.

The method begins at 501 by storing an advertisement message in the WCU via downloading when proximate to a supplier of goods or services or preloading by a supplier of the WCU. Step 503 shows displaying a symbol corresponding to the advertisement message on a display of the WCUU in a manner that does not interfere with the users utilization of the WCU. Again as noted above the symbol can be a fixed or variable iconic symbol indicative of the supplier of goods or services and can be shown flashing or merely enabled and the display of the is symbol can be triggered by proximity or location or at a time or subject to a time constraint.

At 505 the method displays the advertisement message on the display when or in a manner that utilization of the WCU will not be compromised. This is preferably as above discussed triggered by the user interacting with the WCU or the WCU after sensing that the unit or display is not otherwise being used. The advertisement message further includes one or more links to one or more remote files that includes further information regarding the goods or services corresponding to the advertisement message. At 507 the method shows connecting to the remote files via one of the links and step 509 indicates completing an electronic transaction to acquire or pursuant to acquiring the goods or services. Note this is similar to the examples transactions that were discussed with reference to FIG. 3. It is sufficient that an offer for goods or services is made even though such offer may not be consummated.

The processes, discussed above, and the inventive principles thereof are intended to and will alleviate problems caused by prior art advertising systems or approaches particularly push advertising on limited display communications devices such as may be encountered with portable cell phones and the like. Using these principles for handling and displaying advertising messages will provide a more user friendly experience in using the devices and may provide an opportunity for suppliers of the devices and systems to attract advertising revenues, thus facilitating connectivity and electronic commerce for mobile individual. Various principles discussed allow providers to target groups of consumers by showing advertisements based on location and time factors which should dramatically reduces network traffic devoted to push advertising as well as result in more effective advertising budgets.

Various embodiments of methods, systems, and apparatus for displaying advertisement messages so as to minimize intrusion upon a user of an electronic device and still provide for electronic transactions in an efficient and timely manner have been discussed and described. It is expected that these embodiments or others in accordance with the present invention will have application to many wide area networks that provide for mobility of their user or subscriber devices or units as well as wireless local area networks that are coupled to fixed WANS such as the PSTN or internet. The disclosure extends to the constituent elements or equipment comprising such systems and specifically the methods employed thereby and therein. Using the inventive principles and concepts disclosed herein advantageously allows or provides for minimally intrusive but never the less targeted advertising and electronic commerce that will be beneficial to users and providers a like.

This disclosure is intended to explain how to fashion and use various embodiments in accordance with the invention rather than to limit the true, intended, and fair scope and spirit thereof. The invention is defined solely by the appended claims, as may be amended during the pendency of this application for patent, and all equivalents thereof.

What is claimed is:

1. A method of displaying an advertisement on an electronic device that is minimally intrusive for a user of the electronic device, the method including the steps of:
storing an advertisement message in the electronic device;
first displaying a symbol corresponding to said advertisement message on a display of the electronic device in a manner that does not interfere with the users utilization of the electronic device;
initiating a display of said advertisement message when utilization of the electronic device will not be compromised; and
displaying said advertisement message on said display of the electronic device.

2. The method of claim 1 wherein said first displaying said symbol includes displaying an iconic symbol indicative of a supplier of goods or services.

3. The method of claim 2 wherein said first displaying said symbol includes displaying one of a fixed iconic symbol and a variable iconic symbol.

4. The method of claim 3 wherein said first displaying said symbol includes a flashing iconic symbol.

5. The method of claim 2 wherein said first displaying said symbol is triggered by one of proximity to said supplier or time.

6. The method of claim 1 wherein said storing said advertisement message is facilitated by one of a supplier of the electronic device and a supplier of goods or services.

7. The method of claim 6 further including downloading said advertisement message from said supplier based on proximity to said supplier of said goods or services.

8. The method of claim 1 wherein said initiating said display of said advertisement message is triggered by one of the user interacting with the electronic device and the device after sensing that said display is not otherwise being utilized.

9. The method of claim 8 wherein said advertisement message further includes a link to a remote file with further information corresponding to said advertisement message.

10. The method of claim 1 performed by one of a cellular phone, a messaging device, a personal digital assistant, and an entertainment device.

11. A communications device arranged and constructed to display an advertisement so as to limit intrusiveness for a user of the communications device, the communications device comprising in combination:
a transceiver for receiving and sending communications signals;
a user input output (I/O) including a display; and
a controller, coupled to said transceiver and said user I/O, for controlling said transceiver to carry on communications and interfacing with said user I/O, said controller further including a memory for storing an advertisement message, said controller operating to:
interface with said display to display a symbol corresponding to said advertisement message in a manner that does not interfere with the users utilization of the communications device;
initiate a display of said advertisement message when utilization of the electronic device will not be compromised; and
display said advertisement message on said display.

12. The communications device of claim 11 wherein said interface with said display to display said symbol includes displaying an iconic symbol indicative of a supplier of goods or services.

13. The communications device of claim 12 wherein said interface with said display to display said symbol includes displaying one of a fixed iconic symbol and a variable iconic symbol.

14. The communications device of claim 13 wherein said interface with said display to display said symbol includes displaying a flashing iconic symbol.

15. The communications device of claim 12 wherein said interface with said display to display said symbol is triggered by one of proximity to said supplier or time.

16. The communications device of claim 11 wherein said advertisement message is caused to be stored in said memory by one of a supplier of the electronic device and a supplier of goods or services.

17. The communications device of claim 16 wherein said controller and said transceiver operate to download said advertisement message from said supplier based on proximity to said supplier of said goods or services.

18. The communications device of claim 11 wherein said controller operating to initiate said display of said advertisement message is triggered by one of the user interacting with the user I/O and the controller sensing that said display is not otherwise being utilized.

19. The communications device of claim 18 wherein said advertisement message further includes a link to a remote file with further information corresponding to said advertisement message.

20. The communications device of claim 11 being defined as one of a cellular phone, a messaging device, a personal digital assistant, and an entertainment device.

21. A method of doing business with a wireless communications unit (WCU) that includes advertising with limited intrusiveness to a user of the WCU, the method including the steps of:
storing an advertisement message in the WCU;
first displaying a symbol corresponding to said advertisement message on a display of the WCU in a manner that does not interfere with the users utilization of the WCU;
displaying said advertisement message on said display when utilization of the WCU will not be compromised, said advertisement message further including a link to a remote file that includes further information regarding goods or services;
connecting to said remote file and completing an electronic transaction pursuant to acquiring said goods or services.

22. The method of claim 21 wherein said first displaying said symbol includes displaying an iconic symbol indicative of a supplier of goods or services, said iconic symbol being one of a fixed iconic symbol and a variable iconic symbol.

23. The method of claim 22 wherein said first displaying said symbol is triggered by one of proximity to said supplier or time.

24. The method of claim 21 wherein said storing said advertisement message is facilitated by one of a supplier of the WCU and a supplier of goods or services.

25. The method of claim 24 further including downloading said advertisement message from said supplier based on proximity to said supplier of said goods or services.

26. The method of claim 21 wherein said displaying said advertisement message is triggered by one of the user interacting with the WCU and the WCU after sensing that said display is not otherwise being utilized.

27. The method of claim 21 where the WCU is one of a cellular phone, a messaging device, a personal digital assistant, and an entertainment device.
